(19) United States
(12) Patent Application Publication
(10) Pub. No.: US 2005/0185213 A1
(43) Pub. Date: Aug. 25, 2005

(54) Erroneous cable connection detecting system of printer and method thereof

(75) Inventor: Hideharu Miki, Ibaraki (JP)

Correspondence Address: MCGINN & GIBB, PLLC, 8321 OLD COURTHOUSE ROAD, SUITE 200, VIENNA, VA, 22182-3817, US

(73) Assignee: Ricoh Printing Systems, Ltd., Tokyo (JP)

(21) Appl. No.: 11/053,841

(22) Filed: Feb. 10, 2005

(30) Foreign Application Priority Data
Feb. 20, 2004 (JP) P2004-044249

(51) Int. Cl. G06F 15/00

(52) U.S. Cl. 358/1.15

(57) ABSTRACT

A transmission demanding command of demanding the transmission of a response signal for confirming a connection of video interface cables is transmitted to a printer engine section from a printer controller section via a command interface. According to the received transmission demanding command of demanding the transmission of the response signal for confirming the connection of video interface cables, the printer engine section transmits a response signal to the printer controller section via the video interface. The printer controller section compares the response signal with a previously expected signal and detects an erroneous video interface cable connection between the printer controller section and the printer engine section.

### BACKGROUND OF THE INVENTION

1. Field of the Invention

The present invention relates to an erroneous interface cable connection detecting system and a method for detecting an erroneous interface cable connection between a printer controller section and a printer engine section of a printer.

2. Description of the Related Art

In a conventional digital data transmission device including a printer, several systems for detecting an erroneous connection of interface cables are used in the case where devices are connected with each other by a plurality of interface cables. For example, as described in JP-A-2000-200654, the following system is used. A pair of color marks are displayed on both the interface cable and the device, so that the cable connection can be properly made and the color marks can be confirmed even after the connection has been completed, that is, whether or not the connecting work has been properly made can be easily inspected even after the connection has been completed. However, according to this system, since the inspection is visually made, the following problems are encountered. There is a possibility that the occurrence of an erroneous cable connection can not be detected in some cases. In the case where the device is operated under the condition that the cables are erroneously connected, the operation can not be conducted expectedly. In this case, the cause of the erroneous cable connection is investigated and it is found that the cables are erroneously connected. Therefore, it is impossible to immediately detect the erroneous cable connection. Another method is described in JP-A-2001-325116.

### SUMMARY OF THE INVENTION

It is an object of the invention to certainly detect an erroneous interface cable connection by not a visual inspection but a simple structure.

In order to solve the above problems, first, a transmission demanding command for demanding a response signal for confirming a connection of each video interface cable is transmitted to the printer engine section from the printer controller section via the command interface. According to the transmission demanding command of the response signal for confirming the connection of each interface cable which has been received, the printer engine section transmits the response signal to the printer controller section via the video interface. The printer controller section compares the response signal with a previously expected signal so as to detect an erroneous video interface cable connection between the printer controller section and the printer engine section.

According to one aspect of the invention, it is possible to positively detect an erroneous interface cable connection between the printer controller section and the printer engine section of a printer by a simple structure.

### BRIEF DESCRIPTION OF THE DRAWINGS

FIG. 1 is a schematic illustration showing an erroneous cable connection detecting system of the printer of according to one embodiment of the present invention.

### DESCRIPTION OF THE PREFERRED EMBODIMENTS

An erroneous interface cable connection is positively detected by not a visual inspection but a simple structure, is realized without adding another line for detecting an erroneous cable connection between the devices.

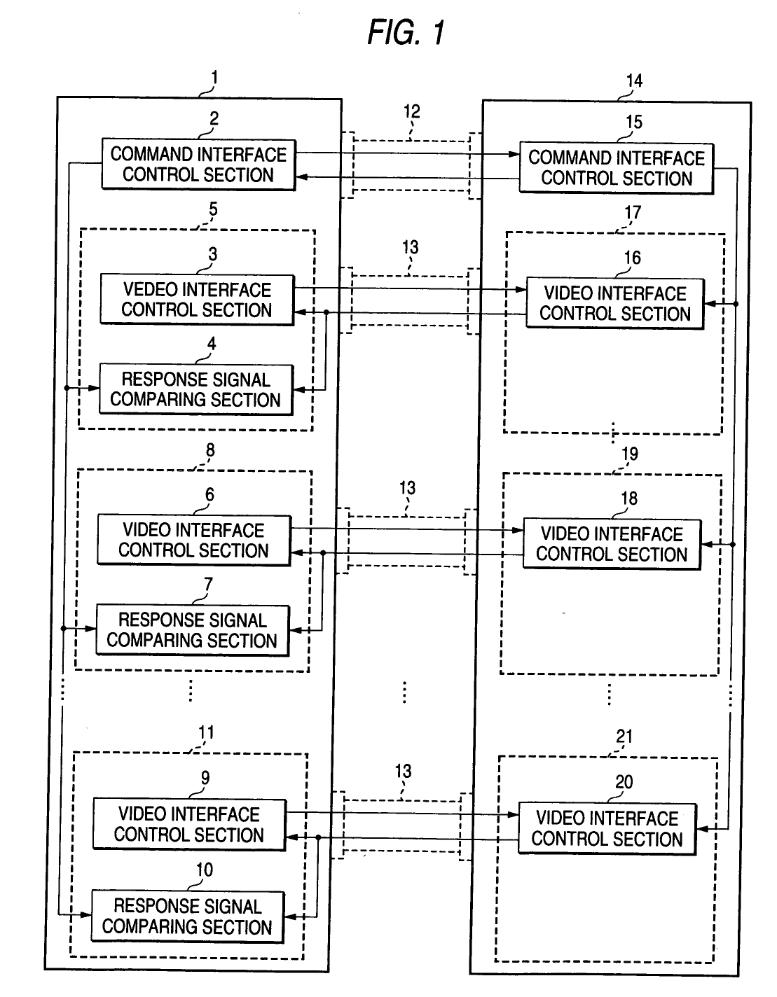

Referring to the drawings, one embodiment of the present invention will be explained below. FIG. 1 is a block diagram showing an example of the constitution of one embodiment of the present invention. The printer device includes: a printer controller section 1; and a printer engine section 14. The devices are connected with each other by the command interface cable 12 and a plurality of video interface cables 13. The printer controller section 1 includes: a command interface control section 2 for controlling a transmission and reception of a command interface signal with the printer engine section 14 via the command interface cable 12; a video interface control section 3 for controlling a transmission of video data via the video interface cable 13; and a response signal comparing section 4 for comparing the response signal, which is transmitted via the video interface cable 13, with a previously expected response signal. Further, a plurality of video interface channels are provided, and the video interface control section and the response signal comparing section are provided for each of the channel 1, the channel 2 and the channel n. The printer engine section 14 includes: a command interface control section 15 for controlling the transmission and reception of the command interface signal with the printer control section 1 via the command interface cable 12; and a video interface control section 16 for conducting the reception of the video data and the transmission of the response signal via the video interface cable 13. Further, a plurality of channels of the video interfaces are provided, and the video interface control section is provided for each of the channel 1, the channel 2 and the channel n.

In the example shown in FIG. 1, the channel 1 of the printer controller section 1 is properly connected to the channel 1 of the printer engine section 14, and the channel 2 of the printer controller section 1 is erroneously connected to the channel 3 of the printer engine section 14.

The printer controller section 1 conducts the connection confirmation of each video interface cable according to the following procedure. First, in the printer controller section 1, the command interface control section 2 designates the channel No. of the video interface, the connection of which is to be confirmed, and generates a connection confirmation demanding command. The thus generated command is sent to the printer engine section 14 via the command interface. When the command interface control section 15 of the printer engine section 14 receives the connection confirmation demanding command, it judges the channel, the connection confirmation of the video interface cable of which is demanded. Then, the command interface control section 15 of the printer engine section 14 gives a direction of generating and transmitting a response signal to the video interface control section of the demanded channel. The video interface control section of the demanded channel generates a response signal and transmits it to the printer controller section 1 via the video interface cable. After the command interface control section 2 of the printer controller section 1 has generated the connection confirmation demanding command, it designates that a response signal is previously expected to the channel response signal comparing section of the channel, the connection confirmation of which is demanded. The designated response signal comparing section makes comparison with the response signal which has been transmitted from the printer engine section 14. In the case where the cables are properly connected to each other (For example, the channels 1 are properly connected to each other in FIG. 1.), the designated response signal comparing section detects a response signal from the printer engine section 14 and judges that the response signals agree with each other by the comparison made in the response signal comparing section and that the cables are properly connected to each other. In the case where the cables are erroneously connected to each other (For example, the channel 2 and the channel 3 are erroneously connected to each other in FIG. 1.), the designated response signal comparing section can not detect a response signal sent from the printer engine section 14. Therefore, the response signals do not agree with each other by the comparison made in the response signal comparing section. Accordingly, the erroneous cable connection can be easily judged.

As described above, according one embodiment of the invention, the erroneous interface cable connection can be positively detected by not the visual inspection but the simple structure.

In the same manner as the connection between the printer controller and the printer engine, the embodiment of the invention can be applied to an erroneous interface cable connection detecting system to detect a connection between the digital data transmission devices which are connected to each other by a plurality of interface cables.

FIG. 1

1 printer controller section
2 command interface control section
3 video interface control section
4 response signal comparing section
5 channel 1
6 video interface control section
7 response signal comparing section
8 channel 2
9 video interface control section
10 response signal comparing section
11 channel n
12 command interface cable
13 video interface cable
14 printer engine section
15 command interface control section
16 video interface control section
17 channel 1
18 video interface control section
19 channel 3
20 video interface control section
21 channel n

1. An erroneous cable connection detecting apparatus of a printer comprising:
a printer controller section for conducting printing control with respect to printing data transmitted from a host computer;
a printer engine section for conducting printing processing with respect to printing data transmitted from the printer controller, wherein
printing is conducted via a command interface and a plurality of video interfaces provided between the printer controller section and the printer engine section,
the printer controller section includes:
a control means for generating a transmission demanding command of a response signal for confirming a video interface cable connection via a command interface with respect to the printer engine section; and
a comparison means for receiving the response signal, which is transmitted from the printer engine section via a video interface, and for comparing the received response signal with a response signal previously expected,
the printer engine section includes:
a control means for generating a response signal according to the transmission demanding command of the response signal, which is received from the printer controller section via the command interface, and for transmitting the response signal to the printer controller section, and
the response signal transmitted from the printer engine section and the response signal previously expected are compared with each other after a response signal transmission demanding command is transmitted by the comparison means so as to detect an erroneous connection of the video interface cable between the printer controller section and the printer engine section.

2. A method for detecting an erroneous cable connection of a printer, comprising the steps of:
designating by a printer controller section a channel number of a video interface, a connection of which is to be confirmed in a command interface control section;
generating and transmitting a connection confirmation demanding command to a printer engine section via a command interface;
judging a channel, a connection confirmation of a video interface cable of which is demanded, when the connection confirmation demanding command is received; giving a direction of generating and transmitting a response signal to a video interface control section of the demanded channel by the printer engine section;
generating and transmitting the response signal to the printer controller section via the video interface cable;
designating that a response signal is previously expected to a channel response signal comparing section of the channel, the connection confirmation of which is demanded after the command interface control section has generated the connection confirmation demanding command;
comparing the response signal previously expected with the response signal which has been transmitted from the printer engine section; and
detecting an erroneous connection of the video interface cable between the printer controller section and the printer engine section by the comparison.
